(19) United States
(12) Patent Application Publication
(10) Pub. No.: US 2014/0012643 A1
(43) Pub. Date: Jan. 9, 2014

(54) METHODS AND SYSTEMS FOR ENCOURAGING RECYCLING

(71) Applicant: Johannes Christoph Behrisch, Cronulla (AU)

(72) Inventor: Johannes Christoph Behrisch, Cronulla (AU)

(73) Assignee: EMPIRE TECHNOLOGY DEVELOPMENT LLC, Wilmington, DE (US)

(21) Appl. No.: 13/699,408

(22) PCT Filed: Jul. 5, 2012
(86) PCT No.: PCT/US12/45536

§ 371 Date: Nov. 21, 2012

(51) Int. Cl. G06Q 10/00

(52) U.S. Cl. CPC G06Q 10/30
USPC 705/14.11

(57) ABSTRACT

Methods and systems for encouraging recycling of used items are disclosed. A central authority receives an indication of a plurality of items and determines a deposit value for each item based on at least an amount and an identity of one or more recyclable materials included in the item. The central authority receives an indication that an item has been sold by a retailer and receives the deposit value for the item from the retailer. The deposit value is invested for the usable life span of the item. The retailer sends a message to the central authority when the item has been returned, and the central authority reimburses the retailer for the deposit value. The return on investment is used to provide subsidies to manufacturers of recyclable material as an incentive to purchase recycled materials.

### BACKGROUND

Recycling is a process for processing used materials or waste into new products in order to prevent the waste of potentially useful materials, to reduce energy usage from the production of new materials, to reduce air pollution caused by the incineration of waste materials, and to reduce water pollution as a result of landfilling. Recycling can reduce the need for conventional waste disposal and lower greenhouse gas emissions as compared with virgin production of new materials.

Recycling efforts have gradually gained traction at city, state and federal levels. For example, many jurisdictions provide recycling bins to encourage residents to increase recycling and to reduce waste production. However, if additional incentives were provided to parties to the recycling process, it would further encourage consumers to recycle their used recyclable materials, manufacturers to manufacture goods that incorporate recycled materials and the like.

Existing economic and financial models are inefficient at incentivizing various stakeholders to recycle. For examples, consumers are reluctant to put effort into assuring that used products such as plastics and electronics end up in appropriate recycling facilities at the end of their usable lives. Likewise, manufacturers are reluctant to use recycled materials in their products due to costs, uncertainties of supply and the poor quality of badly recycled materials. While an economic benefit arises for recyclers to recycle, recovering most metals, some plastics that are used in low complexity products, such as water bottles, and most materials that are used in high complexity products, such as electronics, are often not economically viable to recycle. The financial effort involved in sorting, separating and recycling the materials is higher than the price for which these materials can typically be sold.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a method of encouraging recycling of used items may include receiving at least an indication of a plurality of items at a processing device associated with a central authority, for each of the plurality of items, determining an associated deposit value based upon at least an amount and identity of recyclable materials included in the item at the processing device, receiving an indication that an item has been sold, the indication having been transmitted from at least one retailer to the processing device, receiving the associated deposit value for the sold item by the processing device from the at least one retailer, receiving a returned message at the processing device, the returned message indicating that the sold item has been returned to at least one retailer, and refunding the associated deposit value for the sold item to the at least one retailer to which the sold item was returned by the processing device.

In an embodiment, a system for encouraging recycling of used items may include a processing device and a non-transitory computer-readable storage medium in communication with the processing device. The computer-readable storage medium contains one or more programming instructions that, when executed, cause the processing device to receive at least an indication of a plurality of items, for each of the plurality of items, determine an associated deposit value based upon at least an amount and identity of recyclable materials included in the item, receive an indication from at least one retailer that an item has been sold, receive the associated deposit value for the sold item from the at least one retailer, receive a returned message indicating that the sold item has been returned to at least one retailer, and refund the associated deposit value for the sold item to the at least one retailer to which the sold item was returned.

In an embodiment, a method of commerce that incentivizes purchasers to purchase and return items made from recyclable materials may include providing an item having an associated price for sale by at least one retailer, the associated price comprising a retail value of the item and a deposit value for the item based upon at least an amount and identity of recyclable materials included in the associated item, receiving the associated price for the item at a processing device associated with the at least one retailer from a purchaser in exchange for the item, transferring the deposit value for the item from the processing device to a central authority, receiving a returned item at the at least one retailer, the returned item having an associated deposit value paid by a purchaser of the returned item when the returned item was purchased, returning the associated deposit value for the returned item from the processing device to the purchaser; and receiving a reimbursement of the returned associated deposit value at the processing device from the central authority.

In an embodiment, a commerce system that incentivizes purchasers to purchase and return items made from recyclable materials may include a processing device associated with at least one retailer and a non-transitory computer-readable storage medium in communication with the processing device. The computer-readable storage medium contains one or more programming instructions that, when executed, cause the processing device to: provide an item having an associated price for sale by the at least one retailer, the associated price comprising a retail value of the item and a deposit value for the item, wherein the deposit value is based upon at least an amount and identity of recyclable materials included in the associated item, receive the associated price for the item from a purchaser in exchange for the item, transfer the deposit value for the item to a central authority, receive a returned item having an associated deposit value paid by a purchaser of the returned item when the returned item was purchased, return the associated deposit value for the returned item to the purchaser, and receive a reimbursement of the returned associated deposit value from the central authority.

### BRIEF DESCRIPTION OF THE FIGURES

FIG. 1 depicts a block diagram of the participants, the material flow and the monetary flow in a recyclability program according to an embodiment.

FIG. 2 depicts a flow diagram of an illustrative method of encouraging recycling of used items according to an embodiment.

FIG. 3 depicts a flow diagram of an illustrative method of incentivizing purchasers to purchase and return items made from recyclable materials according to an embodiment.

FIG. 4 depicts a block diagram of illustrative internal hardware that may be used to contain or implement program instructions according to an embodiment.

### DETAILED DESCRIPTION

The present disclosure relates to methods and systems for encouraging recycling of used items by incentivizing stakeholders, such as consumers, manufacturers and recyclers to address inefficiencies in the recycling process. As disclosed herein, purchasers are incentivized to return products at the end of the products' useful life cycles and to consider products that are more recyclable upon subsequent purchases through the use of a deposit scheme in which the deposit is determined based upon the recyclability of the product. The deposit is held by a managing entity and is invested while the purchaser uses the product to subsidize the use of secondary material by manufacturers. Secondary material is supplied by recyclers to manufacturers. Steering manufacturers to prefer recycled materials over virgin (first generation) materials will reduce the amount of virgin materials produced. The organization of the deposit scheme and the logistics involved in distributing used products to recyclers may be handled by a central authority that includes representatives from manufacturers, recyclers and/or local government agencies.

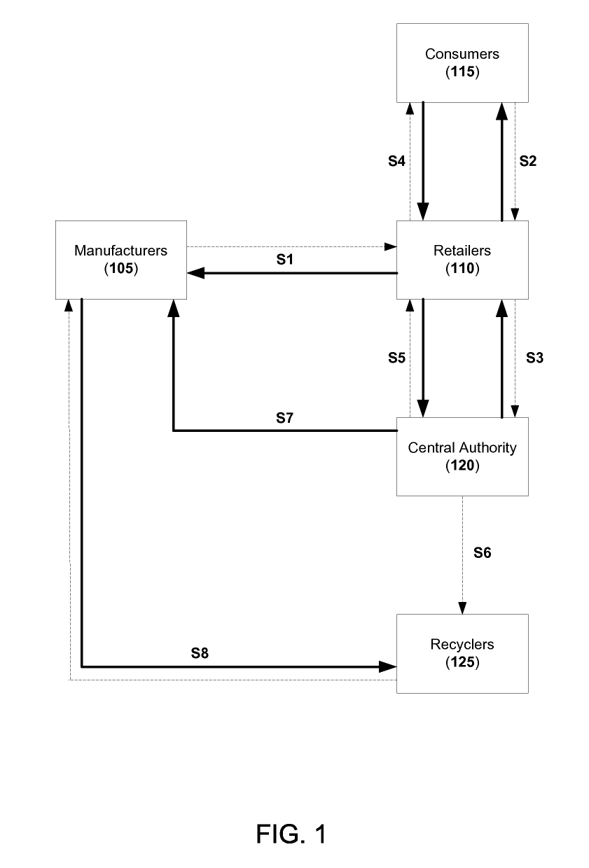

FIG. 1 depicts a block diagram of the participants, the material flow and the monetary flow in a recyclability program according to an embodiment. As shown in FIG. 1, the participants may include one or more manufacturers 105, one or more retailers 110, one or more consumers 115, a central authority 120 and one or more recyclers 125. A manufacturer 105 may sell and deliver a product S1 to a retailer 110. The retailer 110 may, in turn, sell the electronic device to a consumer 115. As part of the purchase price, the consumer 115 may pay a deposit S2 to the retailer 110. The deposit may be separately labeled to the price as part of a purchase display. As such, the purchasing consumer 115 may be incentivized to bring the product back to the retailer 110 at the end of its useful life in order to receive the deposit back S4, as discussed further below. The deposit value may be staggered in order to reflect the recyclability of the product. The deposit may only be paid S2 for products manufactured and sold after a system and method described herein is locally implemented so that deposits are only returned for products purchased under the deposit scheme.

The value of the deposit may be listed in a central database to which the retailer 110 has access. The database may be established and maintained by a central authority, which may include representatives from manufacturers, recyclers and/or local government.

The retailer 110 may send the deposit to the central authority 120 where it is invested for a period of time in order to collect interest S3. In an embodiment, the accumulated deposits may be invested in a capital market for the average time that consumers 115 keep the products. In an embodiment, the deposit may be invested for a period of about 6 months, although other periods of investment may also be used within the scope of this disclosure. The financial means available to the central authority 120 may increase with economic growth and increased consumption rates.

The consumer 115 may return used products to the retailer 110 at the end of the corresponding product's life cycle and may receive a refund of the deposit S4 from the retailer. The retailer 110 may provide the used product to the central authority 120 and may receive a reimbursement of the deposit S5 from the central authority. The central authority 120 distributes the used products S6 to an appropriate recycler 125 for recycling.

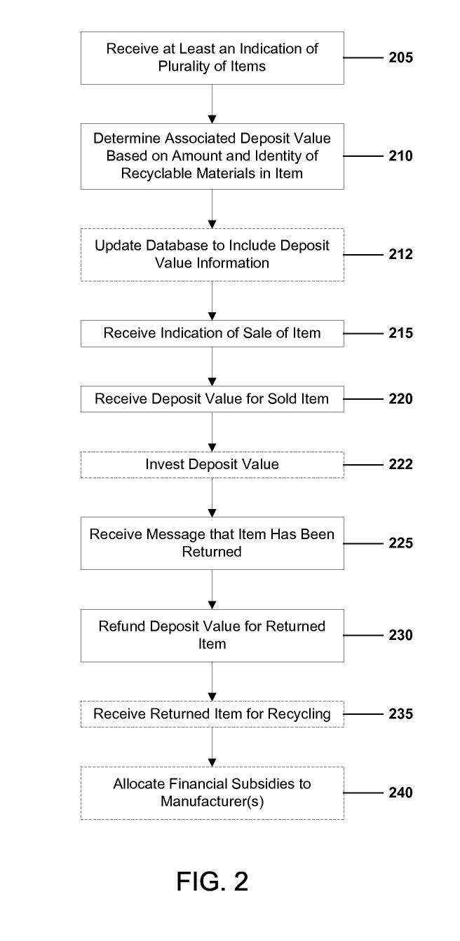

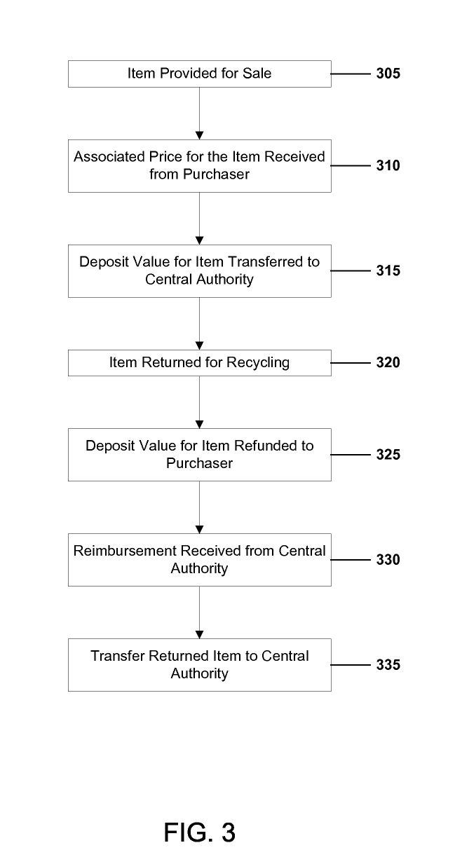

With the interest gained by investing the deposits during the products' life cycles, the central authority 120 may pay subsidies to motivate manufacturers 105 to use locally recycled material S7. The allocation of the subsidies may be determined based at least in part on receiving proof from one or more manufacturers 105 that such manufacturers buy and use recycled materials. In an embodiment, a manufacturer 105 may provide an invoice listing recycled materials purchased from a recycler 125 to the central authority 120 as proof of the purchase of recycled materials. The manufacturer 105 may use the subsidy received from the central authority 120 to purchase additional recycled material S8 from a recycler 125. The process will be described in further detail in reference to FIGS. 2 and 3 below.

The value of the deposit may be determined by the central authority based on the recyclability of the corresponding product. New products may be assessed to determine the financial effort that is required for recyclers to recover the materials used in the product taking into account their current facilities. In addition, the cost of collecting used products may be factored into the subsidy. From this value, the market price for the virgin materials used in the product may be subtracted. The deposit should be sufficient to generate enough income on the capital market to compensate the applicable parties for this difference.

An example method for determining the deposit based on the current market price of the virgin commodity on the market (P), the cost of collecting and recycling the product as determined by recyclers (C), the current interest rate (I), the estimated time that the consumer will keep the product (T), the necessary subsidies for making recycling compatible with virgin material (S), and the minimum deposit required from the consumer (X) may be performed. Using these values, the deposit may be calculated from the following equations:

C−P=S; and

S=└(1+I)^{T}−1┘*X.

Substituting for S results in the following equation:

$$X = \frac{C - P}{{( 1 + I )}^{T} - 1} .$$

In an embodiment, an estimated increase in sales as a result of providing the recycling subsidy may be factored into the determination of the deposit. The above-listed equation merely determines a minimum deposit required for financing the necessary subsidies. This is because there is a threshold below which the inventive for consumers to bring back their old products is not given. The deposit needs to be above that threshold.

Products that are designed to be more easily recyclable may incur less cost for the recycling process. As such, a lower deposit may be required for such products. As such, the deposit may be communicated as a recycling index to the final consumer. Economically motivated and environmentally cautious consumer may increasingly demand products with a low deposit, thereby incentivizing manufacturers to increase their efforts in designing with recycling in mind.

FIG. 2 depicts a flow diagram of an illustrative method of encouraging recycling of used items according to an embodiment. As shown in FIG. 2, a processing device may receive 205 at least an indication of a plurality of items. The processing device may be located at a central authority that oversees a deposit and subsidy scheme for consumers, manufacturers and recyclers. In an embodiment, the plurality of items may include one or more electronic items. In an alternate embodiment, the plurality of items may include one or more consumer goods.

For each of the plurality of items, the processing device may determine 210 an associated deposit value based upon at least an amount and an identity of one or more recyclable materials in the item. For example, the processing device may determine that a particular item includes 8 ounces of a recyclable plastic and 6 ounces of aluminum. Alternate and/or additional materials and amounts of material for particular items may be determined within the scope of this disclosure.

In an embodiment, determining 210 the deposit value may be further based upon an unrecoverable cost associated with recycling the recyclable materials. For example, the deposit value may include a portion of or all of the cost that is incurred in recycling the recyclable materials from the item. The determination 210 of the cost of recycling the recyclable materials from the item may be provided by a recycler.

In an embodiment, the processing device may be operably connected to a non-transitory computer-readable storage medium configured to store a database. In such an embodiment, the processing device may update 212 the database to include information related to the determined associated deposit values for each of the plurality of items. In an embodiment, the processing device may provide access to the database to a plurality of retailers.

The processing device may receive 215 an indication that an item has been sold. In an embodiment, the indication that the item has been sold may be received 215 from at least one retailer that sold the item.

The processing device may receive 220 the associated deposit value for the sold item from at least one retailer. In an embodiment, receiving 220 the associated deposit value may include receiving an indication that the deposit value was received from the at least one retailer, receiving an electronic payment of the deposit value from the at least one retailer, and/or the like. Additional and/or alternate ways of receiving the associated deposit value may be performed within the scope of this disclosure.

The processing device may receive 225 a returned message that indicates that the sold item has been returned to the at least one retailer. In an embodiment, the returned message may identify that a particular item for which a deposit value was paid was received by the retailer. In an embodiment, the identified item may be cross-referenced in a local database to determine the amount of the deposit value that was paid at the time of purchase. In an alternate embodiment, the returned message received 225 from the retailer may indicate the amount of the deposit value.

The processing device may refund 230 the associated deposit value for the sold item to the at least one retailer to which the sold item was returned. The refunded 230 deposit value may be provided in cash, as a check or money order, as an electronic transfer, or the like. In an embodiment, deposit values associated with a plurality of items may be refunded 230 as part of a single payment. In an embodiment, an amount of deposit values to be refunded to a retailer 230 may be subtracted from an amount of deposit values received 220 from the retailer in a given time period in order to reduce the amount of the money to be transferred between the processing device and the retailer.

In an embodiment, the processing device may be used to cause the associated deposit value received 220 from the at least one retailer to be invested 222 for a first time period. In an embodiment, the first time period may be based upon an average life expectancy of the item that was sold and for which the deposit value was received.

In an embodiment, the returned item may be received 235 from the at least one retailer to which the item was returned for recycling. In an embodiment, the sold item may be provided to a recycler for recycling.

In an embodiment, the processing device may allocate 240 one or more financial subsidies to one or more manufacturers. The one or more financial subsidies may be allocated 240 based upon the one or more manufacturers buying and using recycled materials to manufacture items for sale.

FIG. 3 depicts a flow diagram of an illustrative method of incentivizing purchasers to purchase and return items made from recyclable materials according to an embodiment. As shown in FIG. 3, at least one retailer provides 305 an item for sale. The item that is provided 305 by the at least one retailer may have an associated price that includes, without limitation, a retail value of the item and a deposit value for the item. In an embodiment, the deposit value may be based upon at least an amount and identity of recyclable materials included in the associated item. In an embodiment, the deposit value may be further based upon an unrecoverable cost associated with recycling the recyclable materials. In an embodiment, the item for sale may be a consumer good and/or an electronic item.

A processing device associated with the at least one retailer may receive 310 the associated price for the item from a purchaser in exchange for the item. In an embodiment, receiving 310 the associated price may include receiving an indication that the associated price was received from the purchaser, receiving an electronic payment for the associated price from the purchaser, and/or the like. Additional and/or alternate ways of receiving the associated price may be performed within the scope of this disclosure.

The deposit value for the item may be transferred 315 from the processing device to a central authority. In an embodiment, the deposit value may be transferred 315 via an electronic transfer initiated by the processing device. In an alternate embodiment, the processing device may keep track of an amount to transfer 315 for a particular period of time, such as an hour, a day, a week or a month.

The at least one retailer may receive 320 a returned item. The returned item may have an associated deposit value that was paid by the purchaser of the returned item at a time when the returned item was originally purchased. In an embodiment, the amount of the deposit value associated with the item may be stored by the processing device at the at least one retailer. In an alternate embodiment, the at least one processing device may be in operable communication with a database associated with the central authority. In such an embodiment, the database may be configured to store information related to deposit values for a plurality of items for sale, including the associated deposit value for the returned item.

The processing device may return 325 the associated deposit value for the returned item to the purchaser. In an embodiment, the processing device may return 325 the associated deposit value by means of an electronic banking transaction to the purchaser. In an alternate embodiment, the processing device may return 325 the associated deposit value by crediting a credit or debit card of the purchaser. In an embodiment, the processing device may return 325 the associated deposit value by providing a store credit at the at least one retailer to the purchaser. In an alternate embodiment, the processing device may return 325 the associated deposit value by directing an employee of the at least one retailer to provide a cash amount to the purchaser. Additional and/or alternate means of returning 325 the associated deposit value may be performed within the scope of this disclosure.

The processing device may further receive 330 a reimbursement of the returned associated deposit value from the central authority. In an embodiment, receiving 330 the reimbursement may include receiving an indication that the reimbursement was received from the central authority, receiving an electronic payment for the reimbursement from the central authority, and/or the like. Additional and/or alternate ways of receiving the associated reimbursement may be performed within the scope of this disclosure.

In an embodiment, the returned item may be transferred 335 from the retailer to the central authority. The return item may be transferred 335 to the central authority before or after the retailer receives 330 the reimbursement.

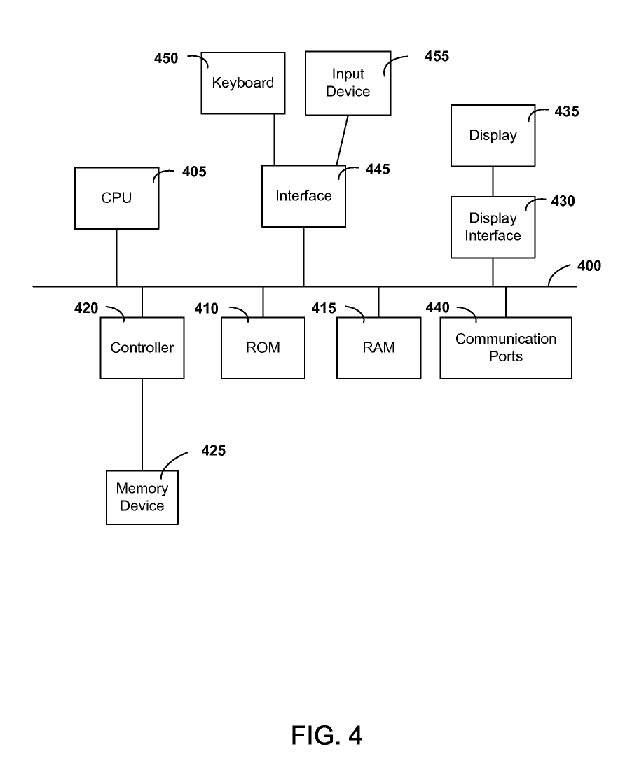

FIG. 4 depicts a block diagram of illustrative internal hardware that may be used to contain or implement program instructions, such as the process steps discussed above in reference to FIGS. 2 and 3, according to an embodiment. A bus 400 serves as the main information highway interconnecting the other illustrated components of the hardware. CPU 405 is the central processing unit of the system, performing calculations and logic operations required to execute a program. CPU 405, alone or in conjunction with one or more of the other elements disclosed in FIG. 4, is an exemplary processing device, computing device or processor as such terms are used within this disclosure. Read only memory (ROM) 410 and random access memory (RAM) 415 constitute exemplary memory devices (i.e., processor-readable non-transitory storage media).

A controller 420 interfaces with one or more optional memory devices 425 to the system bus 400. These memory devices 425 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 410 and/or the RAM 415. Optionally, the program instructions may be stored on a tangible computer readable medium such as a compact disk, a digital disk, flash memory, a memory card, a USB drive, an optical disc storage medium, such as a Blu-ray™ disc, and/or other non-transitory storage media.

An optional display interface 430 may permit information from the bus 400 to be displayed on the display 435 in audio, visual, graphic or alphanumeric format. Communication with external devices, such as a print device, may occur using various communication ports 440. An exemplary communication port 440 may be attached to a communications network, such as the Internet or an intranet.

The hardware may also include an interface 445 which allows for receipt of data from input devices such as a keyboard 450 or other input device 455 such as a mouse, a joystick, a touch screen, a remote control, a pointing device, a video input device and/or an audio input device. In an embodiment, chemical composition information may be received from one or more input devices 455, such as a gas chromatograph, an elemental analyzer, a mass spectrometer, an infrared spectrometer, a liquid chromatograph, a nuclear magnetic resonance imager and/or the like.

### EXAMPLES

### Example 1

### Determination of Deposit Value

The recyclable components of a computing device are determined to include three kilograms of aluminum, one kilogram of recyclable plastic, and one hundred grams of copper. The cost of virgin (i.e., non-recycled) aluminum is $2.20 per kilogram, the cost of virgin plastic is $5.00 per kilogram, and the cost of virgin copper is $6.60 per kilogram. Accordingly, the recyclable materials from the computing device have a value of about $12.26 if produced using virgin materials. The cost of collecting and recycling the materials is about $13, the average lifespan of a computing device is about 2 years, and the current interest rate is about 3% per year. As such, using the equation:

$$X = \frac{C - P}{{( 1 + I )}^{T} - 1} ,$$

the minimum deposit value required from a consumer is

$$\frac{\$13 - \$12 .26}{\$1 {.03}^{2} - 1} = \$12 .15 .$$

### Example 2

### Product Purchase and Return at Retailer

A purchaser visits a retailer and purchases a computer system having a retail price of $1000. The computer system further has a deposit value of $20 based on the components contained in the computer system. The retailer receives the $1020 and provides the $20 deposit value to a central authority. After a period of time, such as 2 years, the purchaser returns the computing device to the retailer and is provided with the deposit value of $20 in store credit. The retailer provides the used computing device to the central authority and is reimbursed for the $20 deposit value payment to the purchaser.

### Example 3

### Distribution of Subsidy to Manufacturers

A central authority receives a $20 deposit for a computing device from a retailer and invests the deposit in a certificate of deposit returning 3% per year for 2 years. At the end of the two year period, the central authority has $21.22 in value from the original $20 deposit. The central authority receives the returned computing device from the retailer and provides the $20 deposit value to the retailer. A portion of the $1.22 is distributed to each of an aluminum manufacturer, a plastics manufacturer and a copper manufacturer as a subsidy to purchase recycled materials. The portion distributed to each manufacturer is based on the cost difference between the recycled material and virgin material.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g.,“a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g.,“a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method of encouraging recycling of used items, the method comprising:
receiving at least an indication of a plurality of items at a processing device;
for each of the plurality of items, determining an associated deposit value based upon at least an amount and an identity of one or more recyclable materials included in the item at the processing device;
receiving an indication that an item has been sold, the indication having been transmitted from at least one retailer to the processing device;
receiving the associated deposit value for the sold item by the processing device from the at least one retailer;
receiving a returned message at the processing device, the returned message indicating that the sold item has been returned to at least one retailer; and
refunding the associated deposit value for the sold item to the at least one retailer to which the sold item was returned by the processing device.

2. The method of claim 1, wherein determining the associated deposit value is further based upon an unrecoverable cost associated with recycling the recyclable materials.

3. The method of claim 1, further comprising investing the associated deposit value for the sold item by the processing device for a first time period.

4. The method of claim 3, wherein the first time period is based upon an average life expectancy of the sold item.

5. The method of claim 1, further comprising receiving the sold item from the at least one retailer to which the sold item was returned for recycling.

6. The method of claim 1, further comprising allocating one or more financial subsidies by the processing device to one or more manufacturers, wherein the one or more financial subsidies are based upon the one or more manufacturers buying and using recycled materials to manufacture items for sale.

7. The method of claim 1, wherein the processing device is operably connected to a non-transitory computer-readable storage medium configured to store a database.

8. The method of claim 7, further comprising updating the database to include information related to the determined associated deposit values for each of the plurality of items by the processing device.

9. The method of claim 7, further comprising providing access to the database to a plurality of retailers by the processing device.

10. The method of claim 1, wherein the plurality of items comprise one or more electronic items.

11. A system for encouraging recycling of used items, the system comprising:
a processing device; and
a non-transitory computer-readable storage medium in communication with the processing device, wherein the computer-readable storage medium contains one or more programming instructions that, when executed, cause the processing device to:
receive at least an indication of a plurality of items,
for each of the plurality of items, determine an associated deposit value based upon at least an amount and identity of recyclable materials included in the item,
receive an indication from at least one retailer that an item has been sold,
receive the associated deposit value for the sold item from the at least one retailer,
receive a returned message indicating that the sold item has been returned to at least one retailer, and
refund the associated deposit value for the sold item to the at least one retailer to which the sold item was returned.

12. The system of claim 11, wherein the one or more programming instructions that, when executed, cause the processing device to determine the associated deposit value comprise one or more programming instructions that, when executed, cause the processing device to determine the associated deposit value based at least upon an amount and identity of recyclable materials included in each of the plurality of items and an unrecoverable cost associated with recycling the recyclable materials.

13. The system of claim 11, wherein the one or more programming instructions further comprise one or more programming instructions that, when executed, cause the processing device to invest the associated deposit value for the sold item for a first time period.

14. The system of claim 13, wherein the first time period is based upon an average life expectancy of the sold item.

15. The system of claim 11, wherein the one or more programming instructions further comprise one or more programming instructions that, when executed, cause the processing device to allocate one or more financial subsidies to one or more manufacturers, wherein the one or more financial subsides are based upon the one or more manufacturers buying and using recycled materials to manufacture items for sale.

16. The system of claim 11, wherein the non-transitory computer-readable storage medium further contains a database.

17. The system of claim 16, wherein the one or more programming instructions further comprise one or more programming instructions that, when executed, cause the processing device to update the database to include information related to the determined associated deposit values for each of the plurality of items.

18. The system of claim 16, wherein the one or more programming instructions further comprise one or more programming instructions that, when executed, cause the processing device to provide access to the database to a plurality of retailers.

19. (canceled)

20. A method of commerce that incentivizes purchasers to purchase and return items made from recyclable materials, the method comprising:
providing an item having an associated price for sale by at least one retailer, the associated price comprising a retail value of the item and a deposit value for the item, wherein the deposit value is based upon at least an amount and identity of recyclable materials included in the associated item;
receiving the associated price for the item at a processing device associated with the at least one retailer from a purchaser in exchange for the item;
transferring the deposit value for the item from the processing device to a central authority;
receiving a returned item at the at least one retailer, the returned item having an associated deposit value paid by a purchaser of the returned item when the returned item was purchased;
returning the associated deposit value for the returned item from the processing device to the purchaser; and
receiving a reimbursement of the returned associated deposit value at the processing device from the central authority.

21. The method of claim 20, wherein the deposit value is further based upon an unrecoverable cost associated with recycling the recyclable materials.

22. The method of claim 20, further comprising transferring the returned item from the at least one retailer to the central authority.

23. The method of claim 20, further comprising accessing a database associated with the central authority by the processing device.

24. The method of claim 23, wherein the database is configured to store information related to deposit values for a plurality of items for sale.

25. The method of claim 20, wherein the item for sale comprises a consumer good.

26. A commerce system that incentivizes purchasers to purchase and return items made from recyclable materials, the system comprising:
a processing device associated with at least one retailer; and
a non-transitory computer-readable storage medium in communication with the processing device, wherein the computer-readable storage medium contains one or more programming instructions that, when executed, cause the processing device to:
provide an item having an associated price for sale by the at least one retailer, the associated price comprising a retail value of the item and a deposit value for the item, wherein the deposit value is based upon at least an amount and identity of recyclable materials included in the associated item,
receive the associated price for the item from a purchaser in exchange for the item,
transfer the deposit value for the item to a central authority,
receive a returned item having an associated deposit value paid by a purchaser of the returned item when the returned item was purchased,
return the associated deposit value for the returned item to the purchaser, and
receive a reimbursement of the returned associated deposit value from the central authority.

27. The system of claim 26, wherein the deposit value is further based upon an unrecoverable cost associated with recycling the recyclable materials.

28. The system of claim 26, wherein the computer-readable storage medium further comprises one or more programming instructions that, when executed, cause the processing device to transfer the returned item to the central authority.

29. The system of claim 26, wherein the computer-readable storage medium further comprises one or more programming instructions that, when executed, cause the processing device to access a database associated with the central authority.

30. The system of claim 29, wherein the database is configured to store information related to deposit values for a plurality of items for sale.

31. (canceled)
